(19) United States
(12) Patent Application Publication
(10) Pub. No.: US 2008/0189311 A1
(43) Pub. Date: Aug. 7, 2008

(54) VISUAL CONTROLS FOR STORED PROCEDURE AND OBJECT RELATIONAL CLASS DEVELOPMENT

(75) Inventors: Antoine Cote, Bellevue, WA (US); Lance Chadwick Delano, Redmond, WA (US); Andrew Joseph Crawley, Redmond, WA (US); Richard Alexander Stanton, Redmond, WA (US); Young Kun Joo, Issaquah, WA (US); Anders Hejlsberg, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/669,968

(22) Filed: Feb. 1, 2007

(51) Int. Cl. G06F 17/30

(52) U.S. Cl. 707/101

(57) ABSTRACT

A development system is provided. The system includes a workspace component to visually display one or more stored procedures and one or more class components. A manipulation component locates the stored procedures onto the class components in order to automatically create methods for the class components.

### BACKGROUND

Integrated development environments (IDEs) provide a common platform and design tools for modern software development. While software is often the most time-consuming and highest risk aspect of electronic product development, it also holds the greatest potential to enhance a design for multiple target applications. Such design tools allow designers to efficiently develop code where graphical user interfaces (GUI) automates and simplifies the configuration of complex programming projects. These tools also enable designers to create source code by enhancing code readability and simplifying code writing. For instance, source code editor features may include syntax coloring, auto-indenting, and shortcut menus that link stored procedure calls to their definitions, declarations, and usages even when these references reside in separate files. Other aspects of the tools include simulation resources to allow designers to develop and debug applications when hardware resources are scarce or unavailable.

One area of software development that is performed on IDEs includes mapping class objects to relational objects, referred to as O/R mapping, and is the latest advancement in modern day programming technologies. It improves the productivity of programmers by many degrees while providing flexibility to adapt to changing business needs. While O/R technology itself provides many benefits to programmers, enabling O/R classes to be created and set up correctly is not an easy task for normal development nor is it well-supported in current programming tools. Without providing adequate tools support, programmers trying to adopt the technology may be forced to write their respective code manually.

A specific example where current tools do not adequately support automated software development relates to stored procedure development, employment, and manipulation. Stored procedures are widely used as default methods to access and modify data for several reasons such as encapsulation of business logic, reusability, security, and maintainability. A stored procedure can be considered a subroutine available to applications accessing a relational database system. Stored procedures (sometimes referred to as sproc or SP) are physically stored in the database.

Typical uses for stored procedures include data validation (integrated into the database) or access control mechanisms. Furthermore, stored procedures are used to consolidate and centralize logic that was originally implemented in applications. Large or complex processing that may require the execution of several SQL statements, for example, can be moved into stored procedures whereby applications then call the procedures from that point forward. Stored procedures are similar to user-defined functions (UDFs), where the major difference is that UDFs can be utilized like any other expression within SQL statements, whereas stored procedures are invoked using a CALL statement. Stored procedures can return result sets such as the results of a SELECT statement. Such result sets can be processed by other stored procedures by associating a result set locator, or by applications.

The precise implementation of stored procedures generally varies from one database system to another, where most major database vendors support them in some form. Depending on the database system, stored procedures can be implemented in a variety of programming languages, for example SQL, Java, C, and C++, for example. Stored procedures written in non-SQL programming languages may or may not execute SQL statements, where the increased adoption of stored procedures led to the introduction of procedural elements to the SQL language. That adoption made SQL an imperative programming language. Most database systems offer proprietary and vendor-specific extensions. One trend that is emerging now is the ability to easily interact with the stored procedures while in a visual programming environment offered by the IDE. This may require software developers to perform manual operations when operating upon and manipulating the stored procedures.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

A development environment and visual workspace is provided where stored procedures can be visually manipulated in accordance with object class components to facilitate automated software development. In an aspect, graphical tools are provided that allow dragging (or other computer control) a stored procedure (or any database function) onto a class component that is visually represented in a designer workspace, whereby the tools automatically creates a method (or methods) on the respective class. This includes automatically wrapping the stored procedure for the respective class and mapping to the underlying stored procedure. Generally, stored procedures have a scalar or subset return set which are associated with one or more class properties. For example, a visual drag operation may include a “Top10Employees” stored procedure component that is manipulated onto an Employee class for inclusion in an Employee Adapter class set of methods.

The graphical tools and workspace allow visually and programmatically creating object/relational (O/R) methods that are based on stored procedures. This includes visually and programmatically associating stored procedures with an O/R class, for example. Also, the tools allow for differentiating which stored procedure to associate with an O/R class based on return values among other aspects. By providing visual controls and associations between O/R classes and stored procedures, small to medium businesses and less skilled developers can more easily create Object-to-Relationally based applications since manual mapping between components is mitigated via automated graphical methods.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a schematic block diagram illustrating a visual development system.

FIG. 2 is a flow diagram that illustrates a process for stored procedure development and automated object/relational mappings.

FIG. 3 is a diagram that illustrates example workspace components and actions.

FIG. 4 illustrates example properties that can be processed a workspace or designer.

FIG. 5 illustrates an example workspace object.

FIG. 6 illustrates an example class designer workspace.

FIG. 7 illustrates design space for class methods.

FIG. 8 illustrates an example of object/relational associations in a visual workspace.

FIG. 9 is a schematic block diagram illustrating a suitable operating environment.

FIG. 10 is a schematic block diagram of a sample-computing environment.

### DETAILED DESCRIPTION

A graphical design environment is provided that enables automated mappings to be generated between object/relational classes and database procedures. In one aspect, a development system is provided. The system includes a workspace component to visually display one or more stored procedures and one or more class components. A manipulation component locates the stored procedures onto the class components in order to automatically create methods for the class components.

As used in this application, the terms “component,” “tool,” “class,” “procedure,” “wrapper,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

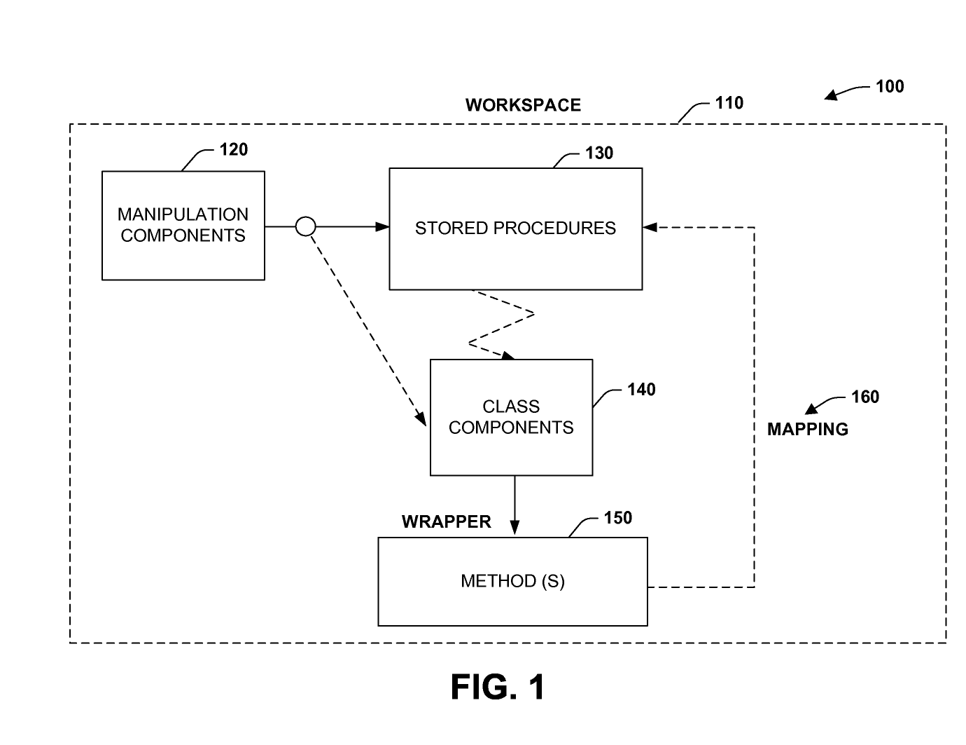

Referring initially to FIG. 1, a visual development system 100 is illustrated to facilitate automated mapping and component development. A work space 110 is provided where developers can create components for an application. Such workspace 110 can be associated with a computer or workstation such as an Integrated Development Environment (IDE), for example, having a display where components can be created and operated upon. Within the workspace 110, one or more manipulation components 120 can be provided that enable developers to visually select and perform operations on a plurality of differing types of components. This can include selecting one or more stored procedures 130 via the manipulation components 120 and locating the components within vicinity of one or more class components 140 (e.g., drag component and drop on another component). For example, the manipulation component 120 may be a computer cursor that selects the stored procedure 130 and drags the procedure such that it visually contacts a portion of the class component 140. By associating the stored procedure 130 with the class component 140, one or more methods are automatically created in a wrapper 150 that are mapped at 160 to the underlying stored procedure 130 that has been selected by the manipulation component 120. It is to be appreciated that other actions than drag and drop can be applied by the manipulation components 120 as will be described in more detail below.

In general, the stored procedures 130 are employed as default methods to access and modify data for several reasons such as encapsulation of logic, reusability, security, and maintainability, for example. In one example, the workspace 110 functions as an object/relational (O/R) designer for stored procedure support making it easy for programmers to take advantage of O/R technology and still being able to utilize existing stored procedures. This includes the ability to visually and programmatically create O/R methods at 150 based on the stored procedures 130. Similarly, this includes visually and programmatically associating the stored procedures 130 with an O/R class at 140, for example although other types of classes can be supported. Also, the workspace 110 and associated components allow differentiating which stored procedure 130 to associate with an O/R class based on a return value or other parameter, for example.

The concept of mapping class objects to relational objects, referred to as O/R mapping, is the latest advancement in modern programming technologies. It improves the productivity of programmers by while providing flexibility to adapt to changing needs. While the technology itself provides benefits to programmers, having O/R classes created and set up correctly is not a straight-forward task for developers. The workspace 110, manipulation components 120, automated method generation at 150, and automated mappings at 160, mitigate programmers having to develop code manually. The system 100 solves this by providing the workspace 110 and automated controls to visually create the classes 140 via drag and drop or other type of manipulation components 120.

The workspace 110 provides a designer platform to determine what actions to take by analyzing the stored procedure 130 located onto the workspace (e.g., computer display screen). An O/R method is created at 150 based on the stored procedure 130 definition. Based on a visual drop target for example and the shape of return value of the stored procedure 130, a different action can be taken by the designer platform. If a component drop target is an existing O/R class 140 and the stored procedure 130 returns scalar values or a result set that has the same shape or shape that is a superset or subset of the target O/R class properties, then a relationship is created between the method that wraps the stored procedure at 150 and the target class 140.

If a drop target is a Methods Pane (described below), a special region in the designer or workspace 110 that has been reserved for O/R methods, or the background surface of the designer/workspace, a method that wraps the stored procedure can be added to an O/R methods list under a desired data context. This functionality adds value to a business by enabling programmers to visually create O/R based applications using O/R technologies (e.g., LINQ to SQL). In another aspect, the system 100 can be employed to create object/relational mappings. The system includes means for creating (workspace 110) one or more class components and means for selecting one or more stored procedures (manipulation components 120). This can also include means for creating a mapping (wrapper 150) between the class components and the stored procedure when the stored procedures are visually associated with the class components.

In addition to various hardware and/or software components, various interfaces can be provided to manipulate components in the workspace 110. This can include a Graphical User Interface (GUI) to interact with the user or other components such as any type of application that sends, retrieves, processes, and/or manipulates data, receives, displays, formats, and/or communicates data, and/or facilitates operation of the system 100. For example, such interfaces can also be associated with an engine, server, client, editor tool or web browser although other type applications can be utilized.

The GUI can include a display having one or more display objects (not shown) for manipulating the stored procedures 130 and classes 140 including such aspects as configurable icons, buttons, sliders, input boxes, selection options, menus, tabs and so forth having multiple configurable dimensions, shapes, colors, text, data and sounds to facilitate operations with the workspace 110. In addition, the GUI can also include a plurality of other inputs or controls for adjusting, manipulating, and configuring one or more aspects. This can include receiving user commands from a mouse, keyboard, speech input, web site, remote web service and/or other device such as a camera or video input to affect or modify operations of the GUI. For example, in addition to providing drag and drop operations of the stored procedures 130 onto the class components 140, speech or facial recognition technologies can be employed to select/locate/move the stored procedure in vicinity of the class component to trigger automated method creation and subsequent mappings.

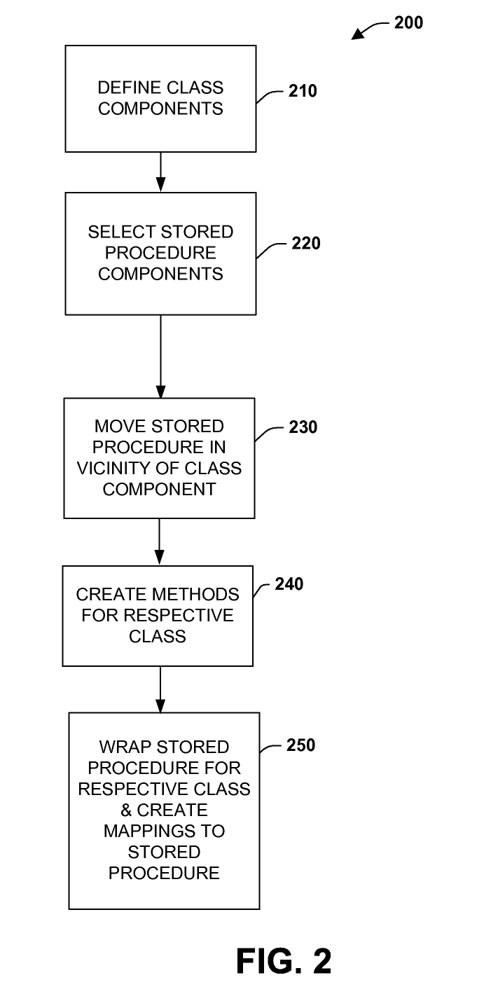

FIG. 2 illustrates exemplary processes 200 for stored procedure development and object/relational mappings. While, for purposes of simplicity of explanation, the process is shown and described as a series or number of acts, it is to be understood and appreciated that the subject processes are not limited by the order of acts, as some acts may, in accordance with the subject processes, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject processes described herein.

Proceeding to 210, one or more class components are defined or developed within the context of a graphical/visual workspace. As noted above, this can include an integrated development environment that provides a visual space or development area where visual objects can be selected from memory and moved onto the space. At 220, stored procedure components are selected. This can include selecting procedures from a list associated with the workspace, menus, tabs, or from visual objects that appear on or near the workspace when stored procedures are available in an associated memory. At 230, the stored procedure selected at 220 is moved within vicinity of a class component created at 210. This could include an operation such as drag and drop or other controls such as eye-monitoring controls or voice activated controls.

At 240, when the stored procedure is moved in vicinity (within a predefined threshold area) or touching the class component defined at 210, one or more methods are automatically created for the respective class component. At 250, the stored procedure is wrapped (code automatically created to interface class with stored procedure) and mappings are created from the respective class back to the underlying stored procedure. As can be appreciated, other class to stored procedure mappings can be created by moving a stored procedure at or near another class component appearing on the workspace.

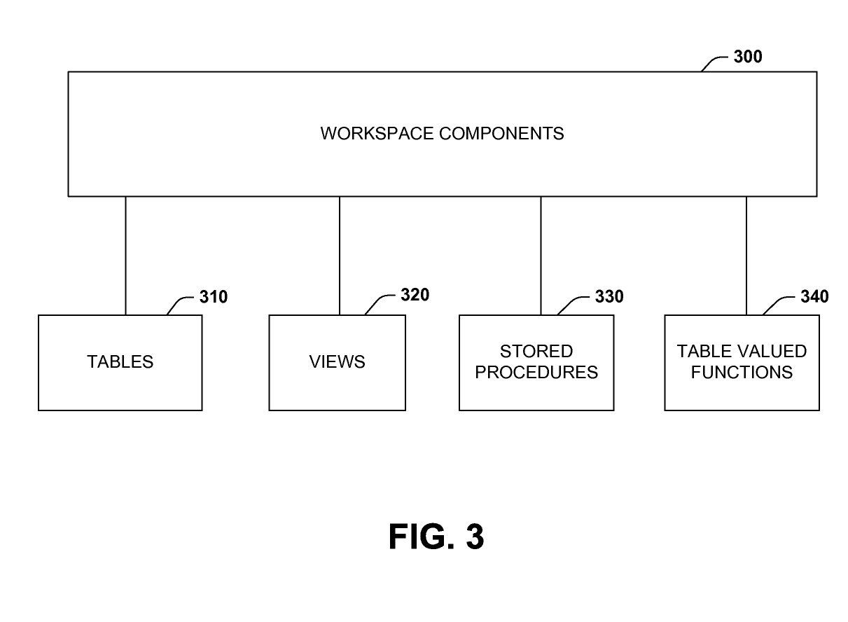

Referring now to FIG. 3, example workspace components 300 and actions are described in more detail. At 310, tables can be provided and manipulated on the workspace. When a user drags over a database table, a designer or workspace creates a new O/R class regardless of where it is dropped. Each column can be created as a property on the class. The primary key for the table is designated as the key for the O/R class. If multiple tables are dragged over, a class can be created for each table and is positioned near the drop target. At 320, workspace views are discussed. When a user drags over a database view of data, the designer creates a new O/R class regardless of where it is dropped. Each column can be processed as a property on the class. Generally, there is no primary key set for this class. In order for a class that represents a view to be updateable, however, a primary key should be designated. When a primary key is set, the task can be cleared. If multiple views are dragged over, a class can be created for each one and positioned near the drop target.

At 330, stored procedures are provided for the workspace. A stored procedure can be dragged onto a diagram or work surface and is added to the data context. A wrapper method for the stored procedure is added to the data context, where a method argument signature matches the stored procedure argument signature. Generally, the method name closely matches the name of the stored procedure. The name may not be an exact match due to system naming restrictions or conflicts. Method name conflicts can be resolved by adding numeric index at the end of the method name to make it unique (MySproc, MySproc1, MySproc2, and so forth). Along with the name, a new method can be added to a Method View which is described in more detail below.

If a stored procedure is dragged onto an existing class shape, and if it is a table returning stored procedure and the shape of result set is similar or superset of the class properties, a method can be added to the data context and return value is set to the class targeted. Otherwise, an error can be thrown. If multiple stored procedures are dragged over onto the designer background—generally—, they are added to the data context and Method View associated with the workspace. If multiple stored procedures are dragged onto an existing class shape and if stored procedures return result sets with matching shape, methods are added to the data context and return value is set to the class targeted. If at least one stored procedure that does not return matching result set is found, those stored procedures are skipped and an error message can be thrown. At 340, table-valued functions can be processed are processed similar to table-returning stored procedures.

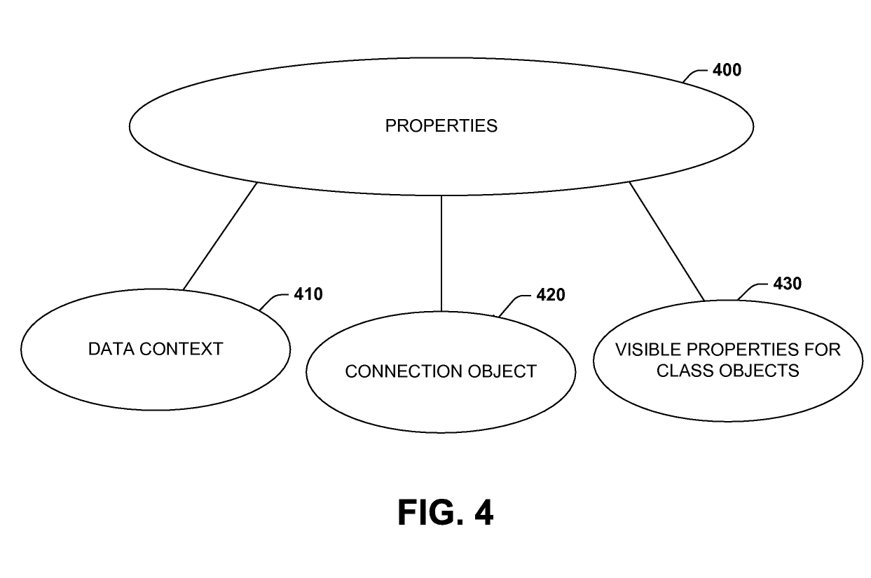

Turning to FIG. 4, example properties 400 that can be processed by a workspace or designer are illustrated. Generally, properties 400 can include data context properties 410, connection object properties 420, and visible properties on class objects among other properties. The tables below describe the properties 410-430 that should be visible in a Properties window when an object (e.g., the Data Context) is selected. Properties that can be edited through a user interface (UI) type editor (including simple drop downs) are designated in the editor column. Generally, each table lists the property name as it will appear in the UI. Object model names may slightly differ. The order in which the properties appear in the table can be the order in which it appears in the property grid. Expansion sections are noted with a “(+)” in front of the property name. Properties below an expansion section are shown in an indented form.

Data Context Properties 410:

| Name | Type | Description |
|---|---|---|
| Base Class | String | Description: Base class from which the data context inherits. |
| | | Behavior: The user can edit this property directly. The code generator can use this property |
| | | for the base class of the data context. |
| Name | String | Description: Name for the data context as it will be generated into code for the data context |
| | | class name. |
| | | Behavior: When the connection is first set. The designer can set the name of the data |
| | | context to a string including first the logical database name and then the string “DataContext” |
| | | post fixed to it. |
| (+) Connection | Object | Description: This object has information about the connection to the database. See the |
| | | Connection object properties below. |
| | | Behavior: The user can choose a connection object from a drop down combo box. The text |
| | | of the property is the My Settings connection property from the settings file or the expanded |
| | | version of connection string (if custom edited). The Drop down also has values for (None) and |
| | | (New Connection). |
| Custom | String | Description: Lists attributes for the Data Context in a read-only comma separated list. User |
| Attributes | | can choose a builder button to launch the Custom Attribute Editor. |
| | | Behavior: Property is read only with a builder button. The builder button brings up a custom |
| | | attribute editor. |
| Access | Enum | Description: Access for the data context (‘public’ and ‘internal’ for C# and for VB but |
| | | substitute ‘friend’ for ‘internal’.) |
| | | Behavior: Drop down combo to choose the value. Code generation uses this value for the |
| | | access modifier. |
| O/R Provider | String | Determines what O/R provider is used for code generation. In addition to Linq to SQL, this |
| | | could be a 3^{rd} party provider. |
| | | Behavior: Drop down shows set of providers registered in registry. |
| <Property> | <value> | Provider supplied set of properties and settable values. |
| | | Behavior: Drop down control shows set of allowable values provided by provider. |
| | | Description Text: Supplied by provider. |

Connection Object Properties 420:

| Name | Type | Description |
|---|---|---|
| Connection | String | Description: This is the run-time connection string for the Linq to SQL data context. |
| String | | Behavior: The user can select the builder button to bring up the common Connection |
| | | Properties Dialog |
| Application | Bool | Description: Specifies whether a connection string is stored in the settings file. |
| Settings | | Behavior: The user can set this value via a drop down control. When the user sets this |
| | | property to True, then the connection string is stored in the settings file. |
| | | If the user sets this property to True and there is no value in the Settings Property Name |
| | | property, then the system iterates through the properties in the .settings file (in the project) and |
| | | tries to find a connection string that matches. If it finds one, then the Settings Property Name |
| | | (see below) is set to the property name in the .settings file. Else, it creates a new property in the |
| | | .settings file using the naming convention of: |
| | | <Database Name> & “Connection” |
| Settings Property | String | Description: Name of the setting property that contains the connection string. |
| Name | | Behavior: The user can edit this property directly. If the user tries to create an invalid |
| | | settings property name (e.g., $$$$$), then an error message dialog can appear which says |
| | | “Invalid Identifier”. If the user changes this property to a new name and a property has already |
| | | been created in the .settings file, then a new property is created in the .settings file and the old |
| | | property in the .settings file will remain. |

Visible properties on Designer Class objects 430:

| Name | Type | Description |
|---|---|---|
| Name | String | Description: Name of the class. |
| | | Behavior: The user can edit the text of the property directly. |
| Access | Enum | Description: Access for the class (‘public’ and ‘internal’ for C# and same for VB but |
| | | substitute ‘friend’ for ‘internal’.) |
| | | Behavior: Drop down combo to choose the value. |
| | | 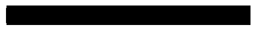 |
| Source | String | Description: Name of the database object (e.g., table, view, etc.) that the class maps |
| | | to. |
| | | Behavior: The user can edit the name directly. This name is used in the attribute that |
| | | maps a class to a database object. |
| Custom Attributes | String | Description: Lists attributes for the Data Context in a read-only comma separated list. |
| | | User can choose a builder button to launch the Custom Attribute Editor. |
| | | Behavior: Property is read only with a builder button. The builder button brings up |
| | | the Error! Reference source not found. |
| Insert | Object | Description: Stored Procedure to use instead of the default insert behavior for Linq |
| | | to SQL. |
| | | Behavior: The user can select a builder button which brings up the Configure |
| | | Behavior dialog. In that dialog, the user can choose from a list of methods that have |
| | | wrapped up stored procedures. |
| Update | Object | Description: Stored Procedure to use instead of the default update behavior for Linq |
| | | to SQL. |
| | | Behavior: The user can select a builder button which brings up the Configure |
| | | Behavior dialog. In that dialog, the user can choose from a list of methods that have |
| | | wrapped up stored procedures. |
| Delete | Object | Description: Stored Proecedure to use instead of the default delete behavior for Linq |
| | | to SQL. |
| | | Behavior: The user can select a builder button which brings up the Configure |
| | | Behavior dialog. In that dialog, the user can choose from a list of methods that have |
| | | wrapped up stored procedures. |
| Entity Class | Bool | Description: Defines whether the class is an Entity Class (i.e., based on a table or |
| | | view) or a non-Entity class (i.e., based on a stored procedure or table valued function) |
| | | Non-Entity classes do not natively support insert, update, or delete behaviors. Entity |
| | | classes do. |
| | | Behavior: If the property is true, then the generated code includes the attribute for |
| | | table, sets the class to be of IQueryable<T>. If the value is false, these are not present |
| | | and it is treated as a stored procedure. The user can change this value. Code validation |
| | | occurs accordingly as per the generated code and the xml file. |

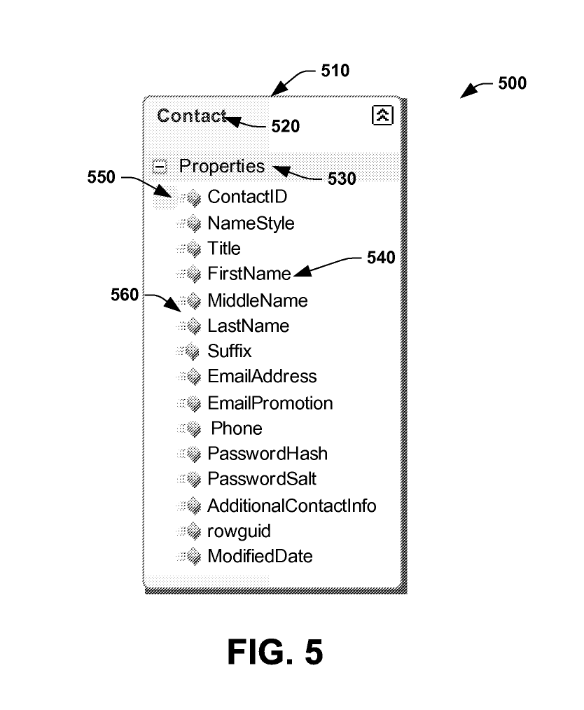

Referring to FIG. 5, an example workspace object 500 is illustrated. Object/Relational (O/R) class objects in the workspace or designer can represent specific generated classes in an e.g., Linq to SQL Object code file (or other type object code). Each class may, and usually is, mapped to a specific database object. The object 500 is an example is of a designer class that is mapped to a database table from a sample database. At 510, an O/R class shape is illustrated where in this example the shape is a rectangle. This basic shape is provided as part of the runtime environment. At 520, an O/R class name is provided where the class name can be bolded and centered. A properties section 530 holds a set of properties and can be sorted alphabetically. At 560, an example of individual properties is illustrated where a primary key icon is provided at 550, and property icons are shown at 560. The set of icons shown at 500 includes specific icons for Private, Public, Protected, Friend and Protected Friend.

The object 500 can include base level functionality, including selection, mouse-over highlights, mouse and keyboard moves, cut, paste, undo, redo, individual element selection, collapse and expand of sections, and so forth. A user can create an O/R class by dragging an O/R class shape 510 from a toolbox or by dragging over an appropriate database object from the database selections. When a class is created on the diagram or workspace, a corresponding class definition is created in the code file.

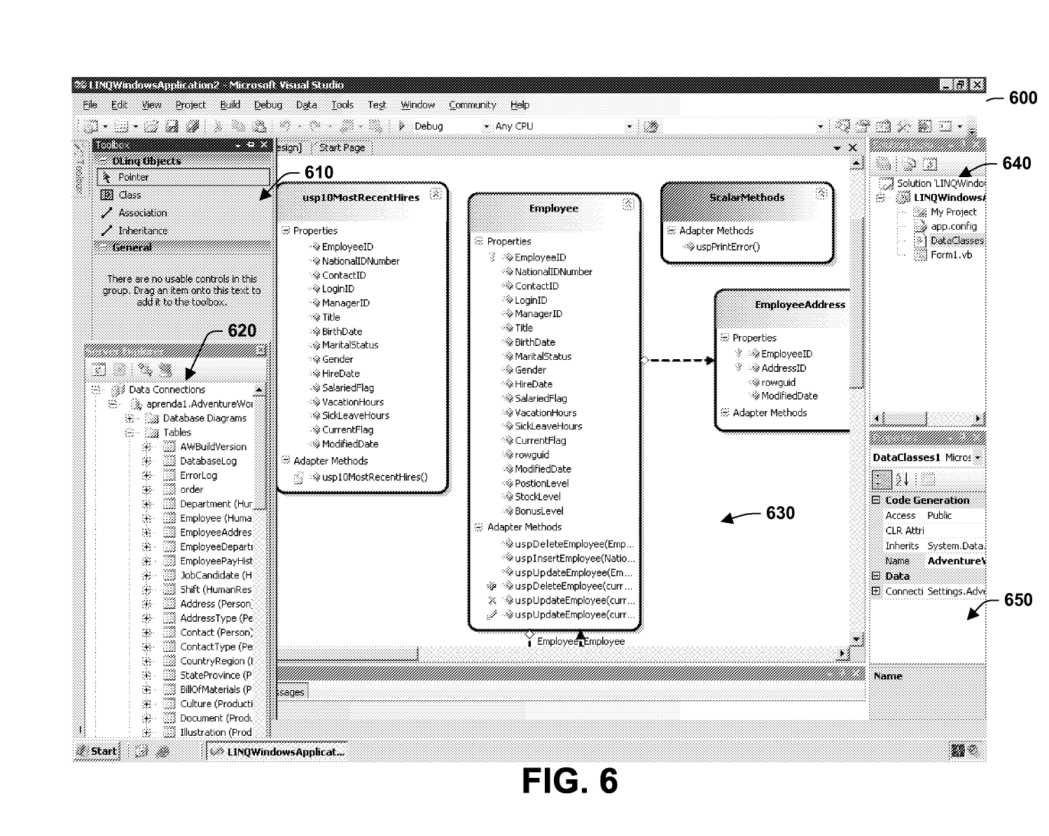

Turning to FIG. 6 an example class designer workspace 600 is illustrated. In general, an object relational (O/R) designer allows users to define an object model and map it to a database. In some examples, the designer generates code for:
1. A set of typed classes that map to tables and stored procedures.
2. A typed data context class—Used to pull and push object to the database.
3. A mapping between the classes and the database (via code attributes, XML file, and so forth). As can be appreciated, other design features can be provided with the workspace 600.

At 610, a Tool Box with O/R Designer objects can be provided. A Sever Explorer component can be provided at 620 showing object locations and an O/R Designer surface is provided at 630. A Solution Explorer 640 can be provided along with a Property window 650. An end-to-end scenario enabled by the O/R Designer is the ability to create Object Class to Relational code file with a designer. Without this feature, a developer must hand-code the entire set of files necessary for Object to Relational Code. Before proceeding it is noted that one or more of the following definitions can apply:

O/R—Object to Relational. This term refers to mapping technologies such as Linq to SQL for example that provide a programmatic run-time map between relational databases objects (such as tables and columns) and program objects (such as classes and properties).

LINQ to SQL—LINQ for databases. This is an example Object to Relational technology.

MProp—Member Property. Classes (e.g., ‘Person’), as they exist in code, can have member properties (e.g., ‘FirstName’). Classes, as they exist on a designer, can also have a different type of property that governs, for instance, how the class is generated into code (e.g., ‘Access Modifier’).

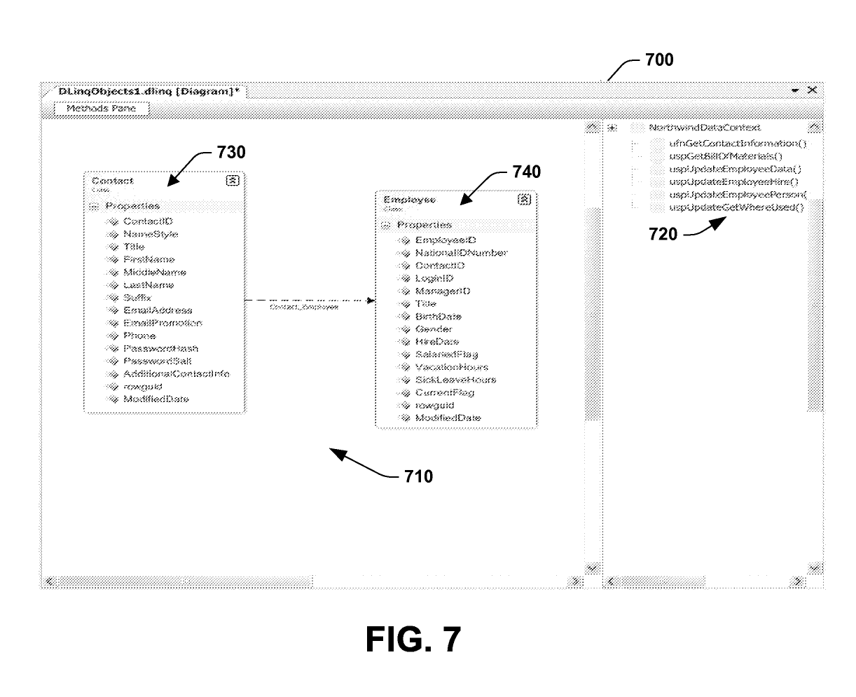

Referring to FIG. 7, an example design space for class methods is illustrated. A graphical designer environment such as shown at 700 includes a number of specific objects and interactions over those objects. In one example, an O/R Designer can have at least two design panes, an entities pane 710 and a methods pane 720, each representing a different part of the model. Users can have the panes open or just the entities pane 710 open if desired. Generally, the entities pane should not be hidden.

The entities pane 710 shows class shapes representing entities in the model. The background of the entities pane 710 is the graphic object that represents the Data Context. The data context is the class that operates with the database. The data context understands about the connection, the specific database, and so forth. It is the data context that has the ability to retrieve objects, insert, update, and/or delete them as needed. In this example, a contact class 730 is shown connected to an example employee class. Generally, an O/R designer instance communicates to one database but other connections are possible. This reflects how the underlying data context works. In order to map objects against other databases, users can add additional designers to the project. As previously noted, the entities pane 710 generally cannot be hidden. When the designer is empty of all classes, it displays a message on the designer background to help prompt the user to drag classes from the Server Explorer shown above in FIG. 6. The methods pane 720 includes one or more methods under data context created form stored procedures and functions. This pane 720 can be turned on or off as desired.

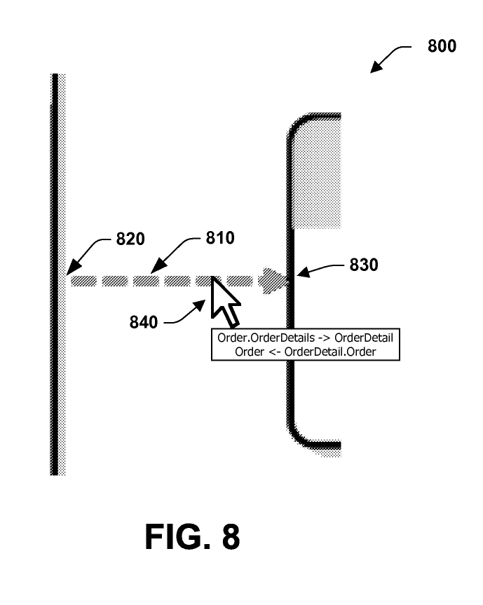

FIG. 8 illustrates an example of object/relational (O/R) associations in a visual workspace. O/R association objects in the designer are associations between classes in the Object to Relational code file. FIG. 8 is an example is of an association between two classes (classes only partially shown and more than two classes can be developed). At 810, an O/R association shape is illustrated which in this example is a dashed arrow but other shapes can be employed. This basic shape is provided as part of a runtime environment. Note that this shape can be similar in theme to a class designer arrow. At 820, an O/R parent connection end is shown whereas at 830 an O/R child connection end is shown. At 840, a Tool tip shows textually, what the association relationships are. In this example, the parent class on the left is Order and the child class on the right is Order Detail. The following interactions can apply:

1. Base level runtime functionality including selection, mouse-over highlights, mouse and keyboard moves, cut, paste, undo, redo, individual element selection, collapse and expand of sections, and so forth can be provided by the a runtime engine. Additive functionality can be specified with appropriate call-outs to the contextual runtime behavior where appropriate.

2. Creation. A user can create an O/R association by first selecting a class on the diagram. Then, the user opens the Tool box and selects the Association shape. This will change the mouse cursor to an association icon. The user then draws the association from the parent class to the target class. Alternatively, the user can bring up the context menu on the class and choose “Insert Association”. This will bring up the New Association Dialog. The user can select a child class, choose OK, and an association will be created between the two classes.

3. Deletion. A user can delete an O/R Association by selecting it and selecting the DELETE key or choosing a CUT operation (from the main or context menu).

4. Editing. The user can edit the O/R association by using the property grid or by double clicking on the association arrow to bring up the Association Editor.

5. Tool tip. The tool tip shows the relationship textually. The form for the first line can be:
<Parent Class Name>.<MemberProperty>-><Child Class Name>

Second line is:
<Parent Class Name><-<Child Class Name>.<Member Property>

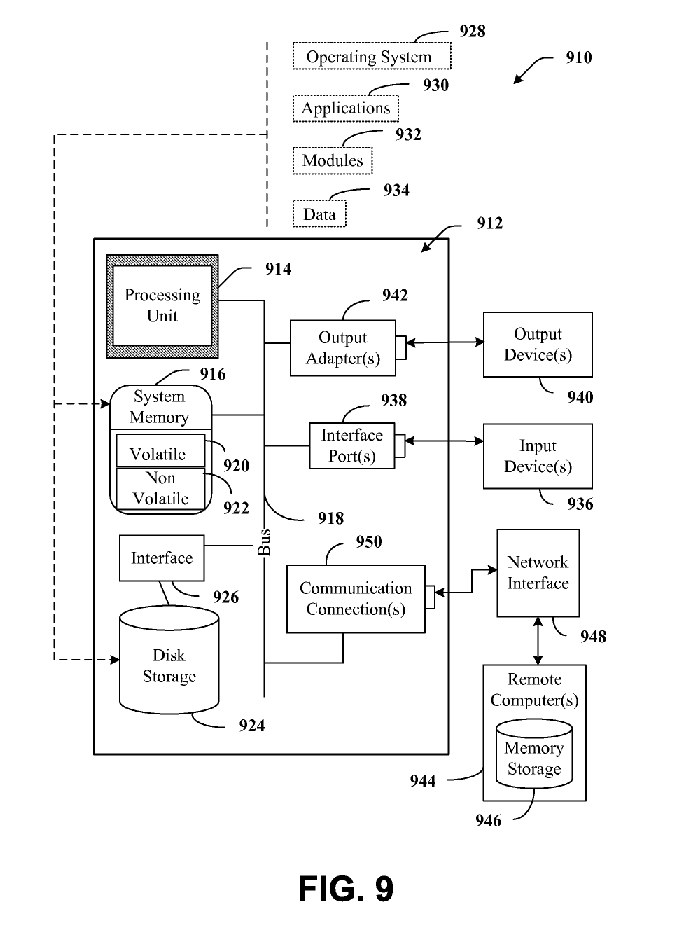

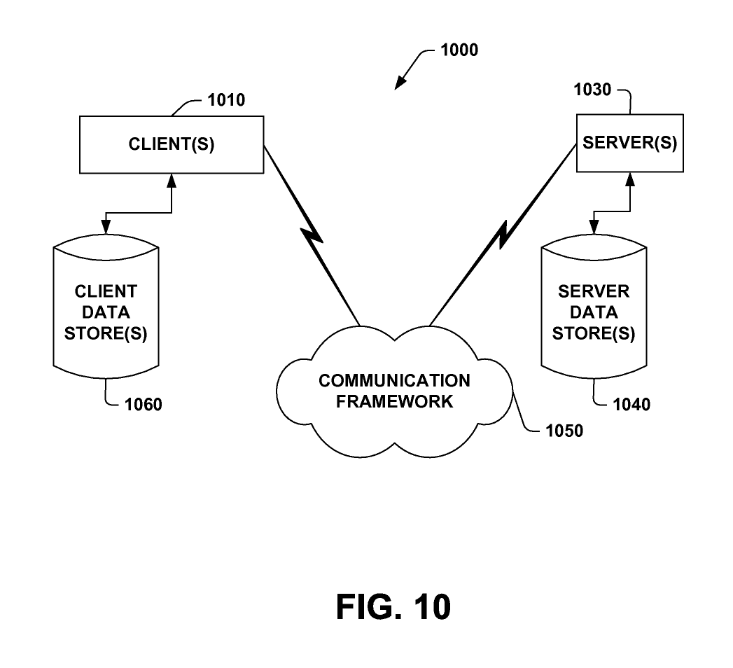

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the invention also may be implemented in combination with other program modules. Generally, program modules include routines, programs, components, data structures, etc. that performs particular tasks and/or implements particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the invention can be practiced on stand-alone computers. In a distributed computing environment, program modules may be located in both local and remote memory storage devices.

With reference to FIG. 9, an exemplary environment 910 for implementing various aspects described herein includes a computer 912. The computer 912 includes a processing unit 914, a system memory 916, and a system bus 918. The system bus 918 couple system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. FIG. 9 illustrates, for example a disk storage 924. Disk storage 924 includes, but is not limited to, devices like a magnetic disk drive, floppy disk drive, tape drive, Jaz drive, Zip drive, LS-100 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that various components described herein can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912 and to output information from computer 912 to an output device 940. Output adapter 942 is provided to illustrate that there are some output devices 940 like monitors, speakers, and printers, among other output devices 940 that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

FIG. 10 is a schematic block diagram of a sample-computing environment 1000 that can be employed. The system 1000 includes one or more client(s) 1010. The client(s) 1010 can be hardware and/or software (e.g., threads, processes, computing devices). The system 1000 also includes one or more server(s) 1030. The server(s) 1030 can also be hardware and/or software (e.g., threads, processes, computing devices). The servers 1030 can house threads to perform transformations by employing the components described herein, for example. One possible communication between a client 1010 and a server 1030 may be in the form of a data packet adapted to be transmitted between two or more computer processes. The system 1000 includes a communication framework 1050 that can be employed to facilitate communications between the client(s) 1010 and the server(s) 1030. The client(s) 1010 are operably connected to one or more client data store(s) 1060 that can be employed to store information local to the client(s) 1010. Similarly, the server(s) 1030 are operably connected to one or more server data store(s) 1040 that can be employed to store information local to the servers 1030.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A development system, comprising:
a workspace component to visually display one or more stored procedures and one or more class components; and
a manipulation component to locate the stored procedures onto the class components in order to automatically create methods for the class components.

2. The system of claim 1, the workspace component visually associates one or more stored procedures with an object/relational (O/R) class.

3. The system of claim 3, further comprising one or more return values that are employed to differentiate which stored procedure to associate with the O/R class.

4. The system of claim 1, the workspace component determines one or more actions by analyzing the stored procedures.

5. The system of claim 4, the actions are based in part by the shape of a return value.

6. The system of claim 4, the actions are based in part by a class drop target.

7. The system of claim 6, the class drop target is an existing O/R class or a methods pane associated with a workspace component.

8. The system of claim 7, where the drop target is the existing O/R class and a stored procedure returns a scalar value or a result set that has a similar shape or a shape that is a superset or a subset of target O/R class properties, a relationship is created between a method that wraps the stored procedure and a target class.

9. The system of claim 7, where the drop target is the methods pane, a region in a workspace component that has been reserved for O/R methods, or a background surface of the workspace component, a method component that wraps a stored procedure is added to an O/R methods list under a data context designation.

10. The system of claim 1, further comprising a properties component that is selected via the manipulation component.

11. The system of claim 10, the properties component is associated with a data context, a connection object, or a visual property.

12. The system of claim 1, the workspace component is associated with a methods pane, an object locator, or an object connection component.

13. The system of claim 12, the workspace component is associated with one or more tables, one or more object views, or one or more table valued functions.

14. The system of claim 12, the workspace component associates the stored procedures with a data context component.

15. The system of claim 12, the object connection component is associated with a visual connection object between object shapes.

16. A method for creating object/relational structures, comprising:
defining one or more class components on a visual workspace;
selecting one or more stored procedures for the visual workspace; and
moving the stored procedures in vicinity of the class components to automatically create methods for the class components.

17. The method of claim 16, further comprising defining an area threshold to determine the vicinity of the class components.

18. The method of claim 16, further comprising generating a wrapper for the stored procedures.

19. The method of claim 16, creating mappings between the class components and the stored procedures.

20. A system to create object/relational mappings, comprising:
means for creating one or more class components;
means for selecting one or more stored procedures; and
means for creating a mapping between the class components and the stored procedure when the stored procedures are visually associated with the class components.
